(19) United States
(12) Patent Application Publication
(10) Pub. No.: US 2013/0060401 A1
(43) Pub. Date: Mar. 7, 2013

(54) APPARATUS AND METHOD FOR PREVENTING A VEHICLE COLLISION, VEHICLE

(71) Applicant: Uwe HAHNE, Buettelborn (DE)

(72) Inventor: Uwe HAHNE, Buettelborn (DE)

(73) Assignee: GM GLOBAL TECHNOLOGY OPERATIONS LLC, Detroit, MI (US)

(21) Appl. No.: 13/598,856

(22) Filed: Aug. 30, 2012

(30) Foreign Application Priority Data
Aug. 30, 2011 (DE) 10 2011 111 895.4

(51) Int. Cl. G08G 1/16

(52) U.S. Cl. 701/2; 701/1

(57) ABSTRACT

An apparatus for preventing a collision, a motor vehicle comprising the apparatus and a method for preventing a collision are provided. An apparatus includes a detection device configured to detect the surroundings of the vehicle and form measurement data, a transmitting/receiving device to transmit and receive the measurement data from other vehicles, and an evaluation device to evaluate the measurement data with a view to an impending collision. A control device has an interface by which the control device controls the vehicle, via which other vehicles in the neighborhood of the vehicle can be controlled, and via which the control device can be controlled by a control device of a vehicle in the neighborhood of the vehicle in such a manner that the impending collision is prevented or a degree of severity of the impending collision is reduced.

### CROSS-REFERENCE TO RELATED APPLICATION

This application claims priority to German Patent Application No. 10 2011 111 895.4, filed Aug. 30, 2011, which is incorporated herein by reference in its entirety.

### TECHNICAL FIELD

The technical field generally relates to an apparatus for preventing a collision, which is provided in a vehicle. The technical field further relates to a method for preventing a vehicle collision and a vehicle.

### BACKGROUND

DE 103 34 203 A1 describes an interactive traffic handling system. Here, at least two road users are informed about the current movement of the respectively other road user by direct intercommunication at least within an adjustable range with respect to one another.

It is at least one object herein to provide an improved apparatus or an improved method for preventing a collision of vehicles. In addition, other objects, desirable features and characteristics will become apparent from the subsequent summary and detailed description, and the appended claims, taken in conjunction with the accompanying drawings and this background.

### SUMMARY

In accordance with an exemplary embodiment, an apparatus for preventing a collision, which is provided in a vehicle, includes a detection device that is configured to detect the surroundings of the vehicle and provide this in the form of measurement data. The apparatus also includes a transmitting/receiving device that is configured to transmit the recorded measurement data and receive measurement data from other vehicles and an evaluation device that is configured to evaluate the recorded and received measurement data with a view to an impending collision. The apparatus also includes a control device having an interface by which means the control device controls the vehicle via which other vehicles in the neighborhood of the vehicle can be controlled, and via which the control device can be controlled by a control device of a vehicle in the neighborhood of the vehicle in such a manner that the impending collision is prevented or a degree of severity of the impending collision is reduced.

A motor vehicle comprising an apparatus for preventing a vehicle collision is also provided in accordance with an embodiment.

In accordance with another embodiment, a method for preventing a collision of a vehicle with at least one other vehicle includes monitoring the surroundings of the vehicle with a view to an impending collision by recording measurement data. The recorded measurement data is transmitted to other vehicles and measurement data is received from the other vehicles. The recorded and received measurement data is evaluated with a view to an impending collision. The vehicle and/or the other vehicles in the neighborhood of the vehicle are controlled in such a manner that the impending collision is prevented or a degree of severity of the impending collision is reduced.

In an embodiment, the apparatus and the method have the advantage that when an impending collision is detected by at least one of the vehicles, vehicles on the one hand exchange information with one another about measures which each vehicle or at least one of the vehicles is initiating. On the other hand, one of the vehicles is determined as master or main controller to a certain extent, which in this case coordinates and controls all other vehicles, which to a certain extent form the slaves or auxiliary controllers in such a manner that the impending collision is prevented or at least the severity of the accident is reduced.

The basic idea herein is to provide a control and evaluation device and a control device where the evaluation device permanently evaluates measurement data about the neighborhood of the vehicle and in particular about an impending collision. By means of the results of this evaluation, it can be determined whether the control device of the vehicle is functioning as the main control device for all the vehicles involved or is controlled by a control device of another vehicle and therefore functions as an auxiliary control device. As main control device, the control device controls and coordinates its own vehicle and the other vehicles involved in the immediate neighborhood of its own vehicle in such a manner that a collision is prevented or the severity of the accident caused by the collision is at least reduced. As auxiliary control device, the control device can, for example, be controlled by another main control device, e.g., the control device of another vehicle or a traffic management system. In this way, the measures of the vehicles for collision avoidance can be specifically matched to one another.

In an embodiment, the control device functions as the main controller and controls at least the vehicle and preferably the other vehicles in the neighborhood if the evaluation device determines that the detection device of the vehicle, as the first before the other vehicles, has detected the impending collision and/or the vehicle has a right of way over the other vehicles.

In another embodiment, the transmitting/receiving device has a radio interface and/or an optical interface for transmitting and receiving data.

In a further embodiment, the control device is configured, depending on the recorded or received measurement data, to produce an intervention command that can be transmitted to a vehicle device of the vehicle and/or by means of the transmitting/receiving device to at least one other vehicle in the neighborhood of the vehicle and which is suitable for preventing a collision and/or reducing the severity of an accident.

In an embodiment, the vehicle device is configured as a braking system, an ABS system, an ESP system, an acceleration system, an electrically actuated steering system, a vehicle headlamp, a vehicle horn, a restraining system such as an airbag, belt tensioner and the like, a back rest, a head rest, a visual, haptic, and/or audible warning system for a vehicle driver.

In another embodiment, the control device is configured to be controlled by control signals of a traffic management system.

In a further embodiment, the control device as the main controller controls the vehicle and/or the other vehicles in the neighborhood of the vehicle in such a manner that the impending collision is prevented or the severity of the accident is at least reduced.

In an embodiment, the control device as an auxiliary controller is controlled by another control device of one of the other vehicles in the neighborhood of the vehicle and/or by a traffic management system, which then functions as the main controller.

In another embodiment, at least one vehicle device of a vehicle that is suitable for avoiding an impending collision and/or for reducing the severity of the impending collision is controlled.

In a further embodiment, no intervention in the vehicle device of the vehicle is made if the evaluation of the measurement data reveals that the impending collision will be prevented without intervention in the vehicle, for example by an intervention controlled by the control device, an intervention by the vehicle driver, or possibly other circumstances.

In an embodiment, an intervention command is output to a control device of the vehicle and/or of another vehicle in the neighborhood of the vehicle in order to prevent the impending collision or reduce the severity of the impending collision.

In another embodiment of the method, the following further steps are provided: determining a degree of severity of a detected impending collision; comparing the degree of severity with a predetermined threshold value; controlling the vehicle and/or other vehicles in the neighborhood of the vehicle if the threshold value is exceeded.

The above embodiments and further developments can be arbitrarily combined with one another if appropriate. Further possible embodiments, further developments and implementations also comprise combinations not explicitly mentioned of features of the various embodiments described previously. In particular, the person skilled in the art will also add individual aspects as improvements or additions to the particular basic form of the embodiments.

### BRIEF DESCRIPTION OF THE DRAWINGS

The various embodiments will hereinafter be described in conjunction with the following drawing figures, wherein like numerals denote like elements, and wherein:

FIG. 1 is a flowchart of a method for avoiding a collision of vehicles according to an embodiment;

FIG. 2 shows a schematic view of a first possible solution to avoid a vehicle collision;

FIG. 3 shows a schematic view of a second possible solution to avoid a vehicle collision;

FIG. 4 shows a schematic view of a third possible solution to avoid a vehicle collision;

FIG. 5 shows a schematic view of a fourth possible solution to avoid a vehicle collision;

FIG. 6 shows a schematic view of a fifth possible solution to avoid a vehicle collision;

FIG. 7 shows a schematic view of a sixth possible solution to avoid a vehicle collision;

FIG. 8 shows a schematic view of a seventh possible solution to avoid a vehicle collision; and

FIG. 9 is a block diagram of a collision avoidance system according to an exemplary embodiment.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

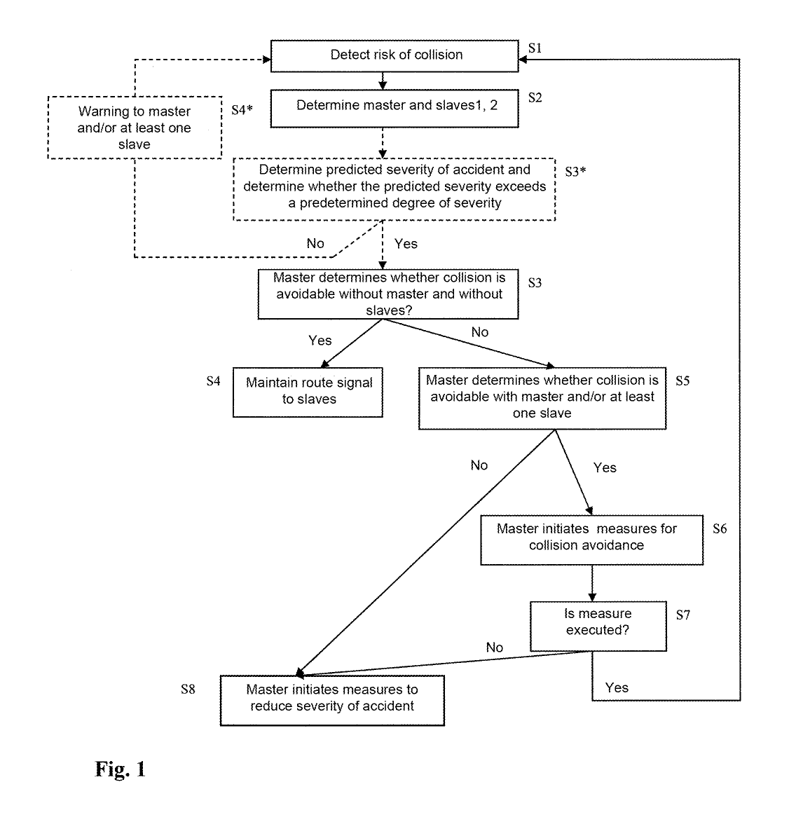

FIG. 1 shows a sequence diagram of one embodiment of a method for collision avoidance.

Present-day collision avoidance systems use environment sensors to detect hazardous driving situations and to prevent these with the aid of active brake interventions or at least reduce the severity of the accident.

However, there are situations in which a collision cannot be avoided without the assistance of other road users. For example, when overtaking on a country road, situations can arise where a collision with the oncoming traffic can only be avoided by the oncoming traffic also initiating an active braking intervention or a swerving maneuver.

In addition, it can be necessary for the vehicle which is just being overtaken, to brake, for example, in order to avoid a collision.

According to an embodiment, the actions of the vehicles are now coordinated with one another so that in the interplay, a collision is ultimately avoided or prevented.

In the case of an impending unavoidable collision between vehicles, the vehicles can, for example, coordinate with one another via a radio interface (e.g. WLAN) so that the collision can still be avoided or its effects minimized. If the cooperation of other vehicles, which are not actually involved, and their systems should be necessary, these can also be activated via the radio interface.

In exemplary embodiments, a master, e.g., a vehicle system as master or master vehicle coordinates the actions of the other vehicles, which in turn act as slave or slave vehicle. The vehicles here each have a control device, where the control device of one vehicle, that forms the master vehicle, is specified as the main control device and the other control devices of the other vehicles, which form the slave vehicles, are specified as auxiliary control devices.

As shown in the exemplary embodiment of a sequence diagram of the method for collision avoidance, in a first step S1 it is initially determined by the vehicles whether a collision risk has been detected. Such a collision risk is detected in particular by a detection device of the particular vehicle which, for example, has environment sensors such as cameras, etc.

If, in the event of an impending accident, several vehicles with their built-in collision avoidance systems and their detection devices simultaneously detect a collision risk (step S1), in a next step S2 the vehicle which, of these vehicles, for example, has the right of way under traffic law, is selected as master, while the other vehicles form the slave vehicles. If several vehicles should register a right of way here, the vehicle which was the first to detect the collision risk, for example, by means of its collision avoidance system and its detection device, is assigned the role of master. Such a collision risk can be detected by a vehicle, for example, by a detection device with environment sensors such as, for example, cameras, radar etc. The method is not however restricted to environment sensors for detecting a collision risk. In principle, any detection device which is suitable for detecting or determining a collision risk can be used. Environment sensors such as, for example, cameras, radar etc. are merely examples for components of such detection devices.

If a collision risk should have been detected by the master vehicle “M” thus specified, in a next step S3 the master vehicle determines whether a collision avoidance is possible if the master vehicle and the slave vehicles continue their travel without any intervention. To this end, the data of the detection device and from other vehicles are sent to a transmitting and receiving device of the master vehicle and the transmitted data are evaluated in an evaluation device of the master vehicle.

If a collision can be avoided (step S3: yes), in a next step S4 a maintain route signal or flag is sent to the slave vehicles.

In the event that a collision is unavoidable without the master vehicle and the slave vehicles (step S3: no), in a next step S5 the master vehicle determines whether the collision can still be prevented by the master vehicle and/or at least one of the slave vehicles.

If it is determined by the master vehicle and its evaluation device that the collision can be prevented by the master vehicle and/or at least one of the slave vehicles (step S5: yes), in a step S6 the master vehicle or its control device functioning as the main control device initiates a measure suitable to prevent the collision. Such a measure is for example, an intervention in a vehicle device such as a braking system, an acceleration system, and/or a steering system etc. of the master vehicle and/or the at least one slave vehicle. In order to introduce such a measure in a slave vehicle, the master vehicle sends a collision prevention intervention command to the associated slave vehicle to carry out the measure in the slave vehicle to prevent the collision.

In a step S7 it can be additionally checked whether the measure is carried out at the respective slave vehicle and whether a response signal is sent from the respective slave vehicle to the master vehicle. If the measure according to the collision prevention intervention command is carried out at the respective slave vehicle and a response signal is sent from the slave vehicle to the master vehicle and its transmitting and receiving device, it is determined in step S7 that the measure is carried out at the slave vehicle (step S7: yes) and the routine can, for example, return to step 51 and check whether a new collision risk is detected.

If on the other hand it is determined in step S7 that the measure is not carried out at the respective slave vehicle and/or no response signal is sent from the respective slave vehicle to the master vehicle and its transmitting and receiving device (step S7: no), in a next step S8 the master vehicle initiates a measure to reduce the severity of the accident.

The same applies to the case where in step S5 it is determined by the master vehicle that the collision cannot be prevented by the master vehicle and/or at least one slave vehicle (step S7: no). In this case, the routine goes to step S8 according to which the master vehicle initiates a measure to reduce the severity of the accident.

To this end the master vehicle at itself and/or at least one of the slave vehicles can carry out the measure which is suitable for reducing the severity of the accident. Here the master vehicle sends an accident severity intervention command via its transmitting and receiving device to a respective slave vehicle to carry out the measure at the slave vehicle in order to reduce the severity of the accident. Furthermore, the master vehicle can execute a measure to reduce the severity of the accident at itself A measure to reduce the severity of the accident is for example, an intervention in a vehicle device such as, for example, a braking system, an acceleration system, an electric steering system for initiating for example a swerving maneuver of the vehicle, a belt tensioning system, an airbag system, a device for adjusting a head rest, and/or a device for adjusting a backrest etc. The embodiments are not restricted to the example for a measure to reduce the severity of the accident; in principle any measure suitable for reducing the severity of the accident can be provided.

In one embodiment, an additional step S3* can additionally be provided as desired following step S2 of determining master and slaves. In step S3* the degree of severity of the predicted accident is determined and compared with a predetermined threshold value for the degree of severity of the accident. If the predicted degree of severity of the accident reaches or exceeds the predetermined threshold value (step S3*: yes), in the next step S3, as described previously, it is determined whether the collision can be prevented or not if master and slaves continue the journey normally.

If, on the other hand, the predicted degree of severity of the accident does not reach the predetermined threshold value, the routine for example, either goes back directly to step S1 and determines whether a new collision risk was detected or in an intermediate step S4* merely outputs a warning, for example, an audible and/or visual warning, to the master vehicle and/or at least one slave vehicle. The threshold value for the degree of severity of the accident can, for example, be determined so that it stands for a moderate or high severity of the accident so that, for example, in the case of lesser predicted sheet-metal damage, merely a warning is output to the vehicles involved, as was described previously with reference to step S4*, but no autonomous braking, acceleration and/or steering interventions are made in the vehicles involved.

In an embodiment, vehicle drivers of vehicles involved (master vehicle, slave vehicle 1, slave vehicle 2) can optionally only be instructed or warned of the danger without autonomous steering, braking or acceleration interventions taking place. In this case, the collision prevention intervention instruction of the master vehicle to a slave vehicle only contains the indication of the risk, e.g. by a measure in which an audible and/or visual signal is triggered in the slave vehicle in order to warn the driver of this vehicle but not to bring about autonomous steering, braking or acceleration interventions in the slave vehicle. To this end, a vehicle device of the vehicle such as, for example a light in the vehicle display can be actuated and light up or a loudspeaker signal can sound.

In another embodiment, the drivers themselves can optionally at any time override any autonomous interventions by an appropriate collision prevention intervention instruction of the master vehicle. In this case, in an embodiment, a modified behavior can optionally be transmitted to the master vehicle in order to give this the possibility, for example, of calculating a new collision avoidance concept.

In addition, optionally, a vehicle initially classified as slave can take over the role of master, for example, by demand request or demand command to the master. This makes sense, for example, if a better collision avoidance strategy was determined on the basis of the environment sensors at the slave vehicle.

In order to enable evaluations and resulting selection behavior for the best concept here, in an optional embodiment, a rating or assessment number can be determined as a function of traffic rules, type and severity of accident and/or the least critical possible influence of the traffic scene. This is initially exchanged between the vehicles and prioritized during the assessment phase of the situation and the determination of the possible intervention possibilities.

In another embodiment, instead of by a master vehicle, the traffic scene can be controlled by an infrastructure in the event of a collision risk. Here, for example, a monitoring system for a crossing is the master and controls the reactions of the individual vehicles or their vehicle drivers in the event of a possible collision. In this case, the vehicles are determined as slave vehicles and the monitoring system as master.

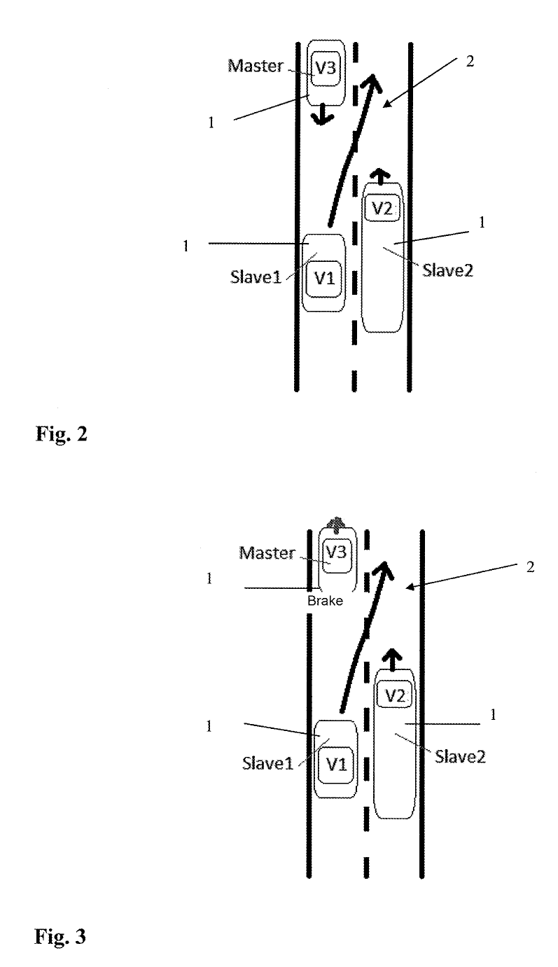

Furthermore, examples of various possible solutions to avoid a collision are explained with reference to FIGS. 2 to 8. These possible solutions can for example be taken into account in step S5 described previously with reference to FIG. 1 in order to determine whether and how a collision with the vehicles 1 involved can be prevented.

The starting situation for all the possible solutions shown in FIGS. 2 to 8 is the fact that a vehicle V1 is overtaking another vehicle V2 on a narrow country road. At the same time a vehicle V3 is approaching. The vehicles 1 involved here are therefore vehicles V1, V2, and V3.

Vehicle V1 and vehicle V3 detect a possible accident risk. As a result of the fact that vehicle V1 is making an overtaking maneuver and is now endangering the oncoming traffic with vehicle V3 contrary to the regulations, vehicle V3 takes over the master role as having the right of way and thus forms the master vehicle.

Firstly, vehicle V3 (master vehicle) assesses whether as first possible solution 1, as shown in FIG. 2, the collision can be avoided by concluding the overtaking maneuver of vehicle V1 (slave vehicle 1). In this case, the master vehicle, here vehicle V3, as was described previously with reference to FIG. 1, sends a route maintaining signal or flag to the two slave vehicles, here vehicles V1 and V2.

If the conclusion of the overtaking maneuver of vehicle V1 should no longer be possible, however, it is calculated whether, as second possible solution 2, as shown in FIG. 3, a braking intervention of vehicle V3 (master vehicle) avoids the collision. If the collision can thus be avoided, in order to initiate such a measure, here the braking intervention at vehicle V2, the master vehicle (vehicle V3) sends a collision prevention intervention instruction to vehicle V2 (slave vehicle) for executing the braking intervention as a measure at vehicle V2 to prevent the collision.

Since the country road 2 is very narrow, a swerving maneuver is initially excluded however so that the collision could not be prevented with the second possible solution.

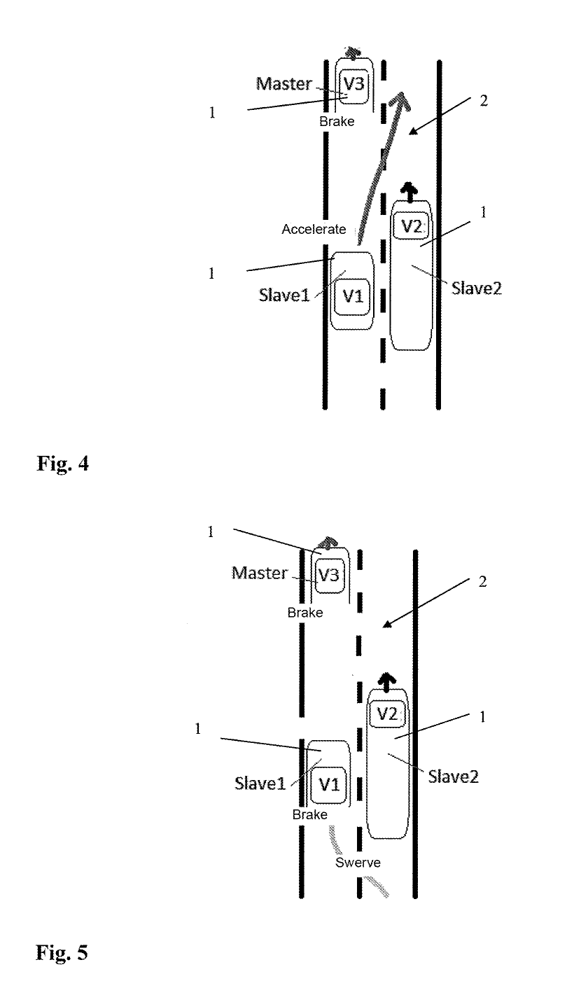

If the result of the calculation therefore still gives an unavoidable collision, as a third possible solution 3, as shown in FIG. 4, the possibility is then checked as to whether the acceleration process can be ended more rapidly by an acceleration of vehicle V1 (slave vehicle 1) or alternatively as fourth possible solution 4, as shown in FIG. 5, whether the overtaking process can be broken off by a braking of vehicle V1 (slave vehicle 1) and going back behind vehicle V2 again (slave vehicle 2).

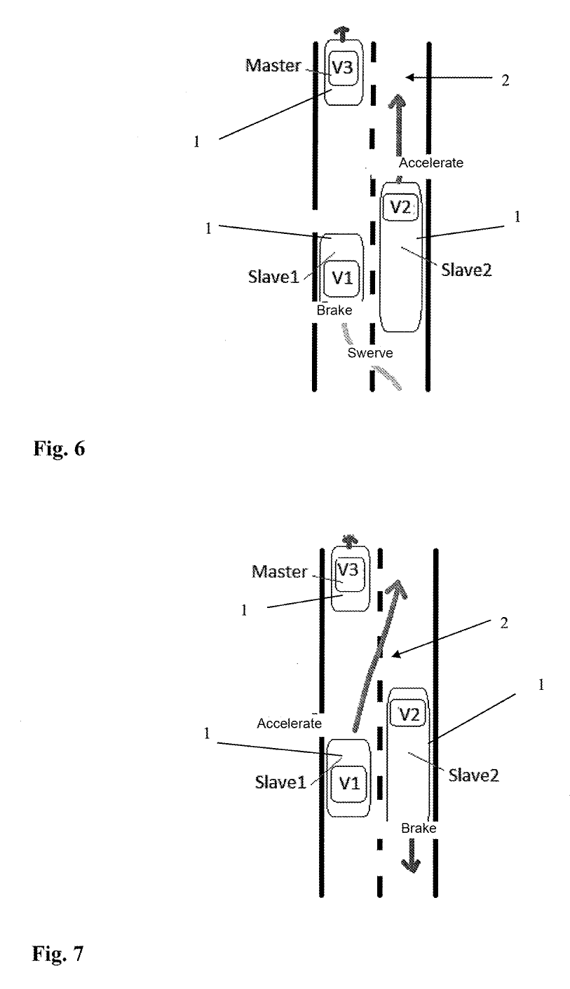

If no positive accident-avoiding result should also be calculated here, it is now calculated in a fifth possible solution 5, as shown in FIG. 6, whether in the case of the deceleration and attempted going back of vehicle V1 (slave vehicle 1) behind vehicle V2 (slave vehicle 2), the vehicle V1 involved in the accident (slave vehicle 1) can now assist by accelerating or the sixth possible solution 6, as shown in FIG. 7, in which the vehicle V1 (slave vehicle 1) completes the overtaking process more rapidly by accelerating and at the same time the uninvolved vehicle V2 (slave vehicle 2) brakes.

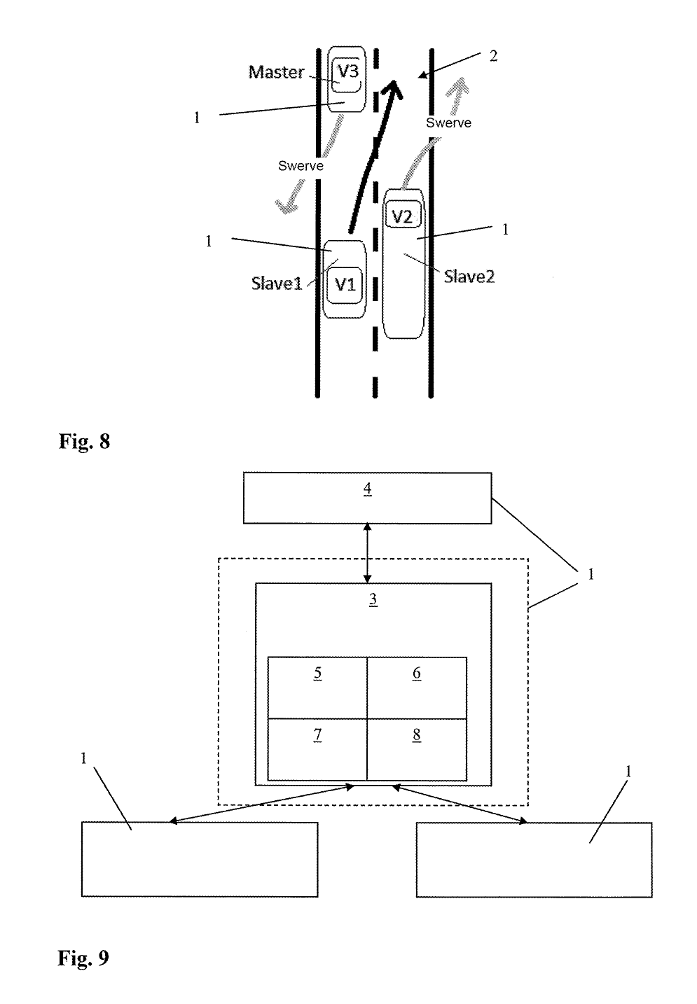

If these calculations should also not give any collision-avoiding result, as seventh possible solution 7, as shown in FIG. 8, the possibility of reducing the severity of the accident is determined and it is calculated whether by a slight swerving maneuver into the roadside ditch, vehicle V3 (master vehicle) and vehicle V2 (slave vehicle 2) can grant vehicle V1 (slave vehicle 1) sufficient free space that it can complete the overtaking. If this is the case, as was described previously with reference to FIG. 1, the master vehicle, here vehicle V3, can send an accident severity intervention command to a particular slave vehicle, here vehicle V2, to execute a measure at the slave vehicle (vehicle V2) in order to reduce the severity of the accident. The measure at vehicle V2 is here the execution of a swerving maneuver into the roadside ditch. The master vehicle also executes a measure to reduce the severity of the accident at itself as vehicle V3. This measure also includes executing a swerving maneuver into the roadside ditch.

FIG. 9 shows an exemplary embodiment of an apparatus 3 for avoidance of a collision of vehicles according to an exemplary embodiment.

In general, many vehicles today have collision avoidance systems as described previously. Such a collision avoidance system is formed with a detection device 4 or coupled to a detection device 4. Furthermore such a collision avoidance system has an evaluation device for evaluating the data recorded by the collision detection device and a control device for controlling one or more vehicle devices on the basis of the recorded data to prevent a collision. Such vehicle devices include, for example, a braking system, an acceleration system, a steering system etc.

According to the embodiment, an apparatus 3 for preventing a collision of vehicles is now provided which can at least be coupled to or formed with such a detection device 4. As a result of the connection of the apparatus 3 according to the embodiment to the detection apparatus 4, the apparatus 3 can now determine whether a collision of vehicles 1 is impending because, for example, a vehicle 1 is overtaking another vehicle 1 in oncoming traffic, as was described previously for example by means of FIGS. 2 to 8.

Furthermore, the apparatus 3 has a transmitting/receiving device 7 for transmitting and receiving data from other vehicles 1, e.g. in a predetermined and, for example adjustable circle around the apparatus 3. The data are preferably exchanged between the vehicles 1 by a standard transmission and receiving protocol.

The transmitting/receiving device 7 has a radio interface 8, e.g. a WLAN interface or an optical interface etc. for data transmission. Via the transmitting/receiving device 7, the apparatus 3 can send its data on the impending collision to other vehicles 1 and conversely receive data on the impending collision detected by these from the other vehicles 1.

The apparatus 3 according to an embodiment further has an evaluation device 5 and a control device 6. The apparatus 3 can itself be configured with the control device 6 or, if the vehicle 1 has a collision avoidance system, be coupled to the control device of the collision avoidance system and/or with its evaluation device.

In the evaluation device 5 the data detected by the detection device 4 and the data on the collision detected by the other vehicles 1 are evaluated according to the method described previously with reference to FIGS. 1 to 8. By means of the results of the evaluation, the evaluation device 5 specifies according to the method described previously with reference to FIGS. 1 to 8 which of the control devices 6 of the vehicles 1 functions as the main control device and therefore as master and which as auxiliary control device and therefore as slave.

The main control device 6 of a vehicle 1, specified as master by the apparatus 3 according to an embodiment, which can also be the vehicle 1 with the apparatus 3 according to an embodiment, now coordinates and controls the actions of the individual vehicles 1 in such a manner that the collision is prevented and if that is not possible, the degree of severity of the predicted accident can at least be reduced.

By means of the apparatus 3, for example, a vehicle 1 can be controlled, which only has a control device 6 and a transmitting/receiving device but no detection device and evaluation device itself. Since, however the vehicle 1 can receive data including commands of the apparatus 3 according to an embodiment at least via its transmitting/receiving device, on the basis of the received commands, the vehicle 1 can control vehicle devices in the vehicle 1 to prevent a collision or to reduce the severity of the accident. Such a vehicle 1 can be specified by control device 6 of the apparatus 3 (master) automatically as slave or auxiliary control device since it cannot execute any evaluation of the received data and determine a collision avoidance strategy itself. If the vehicles 1 present in a predetermined range around the vehicle 1 with the apparatus 3 are those vehicles 1 only having a control device and a transmitting/receiving device, these vehicles are automatically specified as slave by the apparatus 3. The apparatus 3 is again determined as master in this case since due to its evaluation device 5 and control device 6 it is capable of determining collision avoidance concepts and accordingly controlling the slave vehicles and itself on the basis of this collision avoidance concept.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An apparatus for preventing a collision, which is provided in a vehicle, the apparatus comprising:
a detection device configured to detect a surroundings of the vehicle and provide this in the form of measurement data;
a transmitting/receiving device configured to transmit the measurement data and receive measurement data from other vehicles;
an evaluation device configured to evaluate the measurement data with a view to an impending collision; and
a control device which has an interface by which means the control device controls the vehicle, via which the other vehicles in a neighborhood of the vehicle can be controlled, and via which the control device can be controlled by a control device of a vehicle in the neighborhood of the vehicle in such a manner that the impending collision is prevented or a degree of severity of the impending collision is reduced.

2. The apparatus according to claim 1, wherein the control device functions as a main controller and controls the vehicle if the evaluation device determines that the detection device of the vehicle, as a first before the other vehicles, has detected the impending collision and/or the vehicle has a right of way over the other vehicles.

3. The apparatus according to claim 2, wherein the control device functions as the main controller and controls the vehicle and the other vehicles in the neighborhood if the evaluation device determines that the detection device of the vehicle, as a first before the other vehicles, has detected the impending collision and/or the vehicle has a right of way over the other vehicles.

4. The apparatus according to claim 1, wherein the transmitting/receiving device has a radio interface and/or an optical interface for transmitting and receiving data.

5. The apparatus according to claim 1, wherein the control device is configured, depending on the measurement data, to produce an intervention command that is transmitted to a vehicle device of the vehicle and/or by means of the transmitting/receiving device to at least one other vehicle in the neighborhood of the vehicle and which is suitable for preventing the collision and/or reducing a severity of an accident.

6. The apparatus according to claim 5, wherein the vehicle device is configured as a braking system, an ABS system, an ESP system, an acceleration system, an electrically actuated steering system, a vehicle headlamp, a vehicle horn, a restraining system such as an airbag, belt tensioner and the like, a back rest, a head rest, a visual, haptic, and/or audible warning system for a vehicle driver.

7. The apparatus according to claim 1, wherein the control device is configured to be controlled by control signals of a traffic management system.

8. A motor vehicle comprising an apparatus for preventing a vehicle collision, the apparatus comprising:
a detection device configured to detect a surroundings of the motor vehicle and provide this in the form of measurement data;
a transmitting/receiving device configured to transmit the measurement data and receive measurement data from other vehicles;
an evaluation device configured to evaluate the measurement data with a view to an impending collision; and
a control device which has an interface by which means the control device controls the motor vehicle, via which the other vehicles in a neighborhood of the motor vehicle can be controlled, and via which the control device can be controlled by a control device of a vehicle in the neighborhood of the motor vehicle in such a manner that the impending collision is prevented or a degree of severity of the impending collision is reduced.

9. The motor vehicle according to claim 8, wherein the control device functions as a main controller and controls the vehicle if the evaluation device determines that the detection device of the vehicle, as a first before the other vehicles, has detected the impending collision and/or the vehicle has a right of way over the other vehicles.

10. The motor vehicle according to claim 9, wherein the control device functions as the main controller and controls the vehicle and the other vehicles in the neighborhood if the evaluation device determines that the detection device of the vehicle, as a first before the other vehicles, has detected the impending collision and/or the vehicle has a right of way over the other vehicles.

11. The motor vehicle according to claim 8, wherein the transmitting/receiving device has a radio interface and/or an optical interface for transmitting and receiving data.

12. The motor vehicle according to claim 8, wherein the control device is configured, depending on the measurement data, to produce an intervention command that is transmitted to a vehicle device of the vehicle and/or by means of the transmitting/receiving device to at least one other vehicle in the neighborhood of the vehicle and which is suitable for preventing a collision and/or reducing a severity of an accident.

13. The motor vehicle according to claim 12, wherein the vehicle device is configured as a braking system, an ABS system, an ESP system, an acceleration system, an electrically actuated steering system, a vehicle headlamp, a vehicle horn, a restraining system such as an airbag, belt tensioner and the like, a back rest, a head rest, a visual, haptic, and/or audible warning system for a vehicle driver.

14. A method for preventing a collision of a vehicle with at least one other vehicle, the method comprising the steps of:
monitoring a surroundings of the vehicle with a view to an impending collision by recording measurement data;
transmitting the measurement data to other vehicles and receiving measurement data from the other vehicles;
evaluating the measurement data with a view to the impending collision;
controlling the vehicle and/or the other vehicles in a neighborhood of the vehicle in such a manner that the impending collision is prevented or a degree of severity of the impending collision is reduced.

15. The method according to claim 14, wherein a control device as the main controller controls the vehicle and/or the other vehicles in the neighborhood of the vehicle in such a manner that the impending collision is prevented or a severity of an accident is at least reduced.

16. The method according to claim 14, wherein a control device as an auxiliary controller is controlled by another control device of one of the other vehicles in the neighborhood of the vehicle and/or by a traffic management system, which then functions as a main controller.

17. The method according to claim 14, wherein a vehicle device of the motor vehicle, which is suitable for avoiding the impending collision and/or for reducing a severity of the impending collision, is controlled.

18. The method according to claim 17, wherein no intervention in the vehicle device of the vehicle is made if the evaluating reveals that the impending collision will be prevented without intervention in the vehicle.

19. The method according to claim 14, wherein an intervention command is output to a control device of the vehicle and/or of another vehicle in the neighborhood of the vehicle in order to prevent the impending collision or reduce a severity of the impending collision.

20. The method according to claim 14, comprising additional steps of:
determining a degree of severity of a detected impending collision;
comparing the degree of severity with a predetermined threshold value; and
controlling the vehicle and/or the other vehicles in the neighborhood of the vehicle if a threshold value is exceeded.
